(19) United States
(12) Patent Application Publication
(10) Pub. No.: US 2026/0311098 A1
(43) Pub. Date: Oct. 8, 2026

(54) METHOD AND SYSTEM FOR AUTOMATIC CONVERSION OF ARCHITECTURAL DIAGRAM INTO PROJECT ASSESSMENT REPORT

(71) Applicant: JPMorgan Chase Bank, N.A., New York, NY (US)

(72) Inventors: Anvesh MINUKURI, Wilmington, DE (US); Shubham SHAH, Rajkot (IN); Jayanth GOPU, Hyderabad (IN); Andrew DIMAIO, Upper Chichester, PA (US); Venkata GUNNU, Malvern, PA (US); Ami EHLENBERGER, Lansdale, PA (US); Ramu KIZHAKKEY, Downingtown, PA (US)

(73) Assignee: JPMorgan Chase Bank, N.A., New York, NY (US)

(21) Appl. No.: 19/631,221

(22) Filed: Mar. 27, 2026

(30) Foreign Application Priority Data
Apr. 2, 2025 (IN) 202511032620

(51) Int. Cl. G06Q 10/0637; G06V 10/20

(52) U.S. Cl. CPC G06Q 10/0637; G06V 10/255

(57) ABSTRACT

Various methods and processes, apparatuses or systems, and media for automatically converting an architectural diagram into a structured textual report that includes an analysis of project flaws, technical gaps, and compliance with applicable guidelines are disclosed. The method includes: receiving an architectural diagram that relates to a project; using a generative artificial intelligence (AI) model to automatically analyze the architectural diagram; generating, based on a result of the analysis, a description of services associated with the project and an explanation of dependencies and interactions among the services; comparing, based on the result of the analysis, the project with each of a set of security standards and a set of compliance requirements; generating, based on the result of the analysis, recommendations for improving a performance associated with the project; and generating a report based on the description, the explanation, a result of the comparison, and the recommendations.

### CROSS-REFERENCE TO RELATED APPLICATIONS

This application claims priority benefit from Indian Application No. 202511032620, filed on Apr. 2, 2025, in the India Patent Office, which is hereby incorporated by reference in its entirety.

### TECHNICAL FIELD

This disclosure relates to methods and apparatuses for automatically converting an architectural diagram into structured text that includes analysis of project flaws, technical gaps, and compliance with applicable guidelines.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Many projects rely upon critical information that is embedded in architectural diagrams and technical documents. Such information often includes details relating to deviations, technical gaps, innovations, costs, inefficiencies, and deployment violations.

Conventional methods for extracting and analyzing such information are manual, biased, and error-prone. In this regard, these conventional methods typically require significant human intervention and often delay deployment assessments. In addition, when errors occur, it is not always clear what the sources of the errors are, such that conventional methods often require redeployment and retesting. A technical problem with such methodology is that each redeployment and retest consumes a great deal of computer resources and electrical power, such that repetition thereof in search of a satisfactory deployment consumes that much more power and computer resources.

Accordingly, there is a need for a mechanism for automatically converting an architectural diagram into structured text that includes analysis of project flaws, technical gaps, and compliance with applicable guidelines.

### SUMMARY

The present disclosure, through one or more of its various aspects, embodiments, and/or specific features or sub-components, provides, among other features, various systems, servers, devices, methods, media, programs, and platforms for automatically converting an architectural diagram into structured text that includes analysis of project flaws, technical gaps, and compliance with applicable guidelines.

According to an aspect of the present disclosure, a method for automatically converting an architectural diagram into a textual document is provided. The method may be implemented by at least one processor. The method may include: receiving a first architectural diagram that relates to a first project; using a generative artificial intelligence (AI) model to automatically analyze the first architectural diagram; generating, based on a result of the analysis, a description of at least one service associated with the first project and an explanation of dependencies and interactions among each of the at least one service; comparing, based on the result of the analysis, the first project with each of a predetermined set of security standards and a predetermined set of compliance requirements; generating, based on the result of the analysis, at least one recommendation for improving a performance associated with the first project; and generating a report based on the description, the explanation, a result of the comparison, and the at least one recommendation.

The generating of the description may include detecting each of a plurality of icons included in the first architectural diagram and cross-referencing each detected icon with a corresponding contextual embedding that is stored in a database.

The generating of the description may further include generating, for each of the at least one service, a corresponding purpose, a corresponding set of configurations, and a corresponding set of best practices.

The method may further include training the generative AI model by: using a convolutional neural network to recognize cloud service icons by detecting patterns, shapes, and edges that correspond to particular cloud services and applying convolutional layers to highlight attributes of the cloud service icons; and using a vision transformer to: capture long-range dependencies between the cloud service icons; process a training diagram as a series of tokens in order to determine a structure and a layout of the training diagram; and provide positional encoding that corresponds to spatial relationships among the cloud service icons.

The method may further include further training the generative AI model by: performing a cross-attention operation that includes aligning visual data with corresponding textual data for each of the cloud service icons; performing a role contextualization operation that distinguishes between at least a first one of the cloud service icons and at least a second one of the cloud service icons; using hierarchical attention layers to capture details that relate to the cloud service icons; and generating insights that include functional roles and performance suggestions for each of the cloud service icons.

The method of claim 1, wherein the predetermined set of security standards includes a C1 context diagram that relates to system interactions with external entities, a C2 container diagram that relates to an architectural design of a cloud system, a C3 component diagram that relates to an internal structural design of containers within the cloud system, and a C4 code diagram that relates to an accuracy and a flexibility of the architectural design of the cloud system.

The method may further include receiving a user input that relates to at least one focus area of the first project. The generating of the report may include tailoring the report based on the received user input.

The at least one recommendation may include at least one from among a first recommendation that relates to a firewall rule associated with the first project, a second recommendation that relates to data encryption associated with the first project, and a third recommendation that relates to implementing an identity and access management (IAM) role associated with the first project.

The at least one recommendation may further include at least one from among a fourth recommendation that relates to scaling a configuration for a load balancer associated with the first project and a fifth recommendation that relates to caching for a database service associated with the first project.

According to another embodiment, a computing apparatus for automatically converting an architectural diagram into a textual document is provided. The computing apparatus includes a processor; a memory; and a communication interface coupled to each of the processor and the memory. The processor may be configured to: receive, via the communication interface, a first architectural diagram that relates to a first project; use a generative artificial intelligence (AI) model to automatically analyze the first architectural diagram; generate, based on a result of the analysis, a description of at least one service associated with the first project and an explanation of dependencies and interactions among each of the at least one service; compare, based on the result of the analysis, the first project with each of a predetermined set of security standards and a predetermined set of compliance requirements; generate, based on the result of the analysis, at least one recommendation for improving a performance associated with the first project; and generate a report based on the description, the explanation, a result of the comparison, and the at least one recommendation.

The processor may be further configured to generate the description by detecting each of a plurality of icons included in the first architectural diagram and cross-referencing each detected icon with a corresponding contextual embedding that is stored in a database.

The processor may be further configured to generate the description by generating, for each of the at least one service, a corresponding purpose, a corresponding set of configurations, and a corresponding set of best practices.

The processor may be further configured to train the generative AI model by: using a convolutional neural network to recognize cloud service icons by detecting patterns, shapes, and edges that correspond to particular cloud services and applying convolutional layers to highlight attributes of the cloud service icons; and using a vision transformer to: capture long-range dependencies between the cloud service icons; process a training diagram as a series of tokens in order to determine a structure and a layout of the training diagram; and provide positional encoding that corresponds to spatial relationships among the cloud service icons.

The processor may be further configured to further train the generative AI model by: performing a cross-attention operation that includes aligning visual data with corresponding textual data for each of the cloud service icons; performing a role contextualization operation that distinguishes between at least a first one of the cloud service icons and at least a second one of the cloud service icons; using hierarchical attention layers to capture details that relate to the cloud service icons; and generating insights that include functional roles and performance suggestions for each of the cloud service icons.

The predetermined set of security standards may include a C1 context diagram that relates to system interactions with external entities, a C2 container diagram that relates to an architectural design of a cloud system, a C3 component diagram that relates to an internal structural design of containers within the cloud system, and a C4 code diagram that relates to an accuracy and a flexibility of the architectural design of the cloud system.

The processor may be further configured to: receive, via the communication interface, a user input that relates to at least one focus area of the first project; and tailor the report based on the received user input.

The at least one recommendation may include at least one from among a first recommendation that relates to a firewall rule associated with the first project, a second recommendation that relates to data encryption associated with the first project, and a third recommendation that relates to implementing an identity and access management (IAM) role associated with the first project.

The at least one recommendation may further include at least one from among a fourth recommendation that relates to scaling a configuration for a load balancer associated with the first project and a fifth recommendation that relates to caching for a database service associated with the first project.

According to yet another embodiment, a non-transitory computer readable storage medium storing instructions for automatically converting an architectural diagram into a textual document is provided. The storage medium includes a set of executable code which, when executed by a processor, may cause the processor to: receive a first architectural diagram that relates to a first project; use a generative artificial intelligence (AI) model to automatically analyze the first architectural diagram; generate, based on a result of the analysis, a description of at least one service associated with the first project and an explanation of dependencies and interactions among each of the at least one service; compare, based on the result of the analysis, the first project with each of a predetermined set of security standards and a predetermined set of compliance requirements; generate, based on the result of the analysis, at least one recommendation for improving a performance associated with the first project; and generate a report based on the description, the explanation, a result of the comparison, and the at least one recommendation.

When executed, the executable code may further cause the processor to generate the description by detecting each of a plurality of icons included in the first architectural diagram and cross-referencing each detected icon with a corresponding contextual embedding that is stored in a database.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a method for automatically converting an architectural diagram into structured text that includes analysis of project flaws, technical gaps, and compliance with applicable guidelines, in accordance with an embodiment.

FIG. 2 illustrates an exemplary diagram of a network environment with a device for automatically converting an architectural diagram into structured text that includes analysis of project flaws, technical gaps, and compliance with applicable guidelines, in accordance with an embodiment.

FIG. 3 illustrates a system diagram for implementing a method for automatically converting an architectural diagram into structured text that includes analysis of project flaws, technical gaps, and compliance with applicable guidelines, in accordance with an embodiment.

FIG. 4 illustrates an exemplary flow chart of a process for automatically converting an architectural diagram into structured text that includes analysis of project flaws, technical gaps, and compliance with applicable guidelines, in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

As disclosed herein, a system or method for automatically converting an architectural diagram into structured text that includes analysis of project flaws, technical gaps, and compliance with applicable guidelines may improve interoperability, security, and efficiency by ensuring that for any particular architectural diagram, a descriptive and accurate report is automatically generated. In particular, the system or method may achieve these improvements by: receiving an architectural diagram that relates to a project; using a generative artificial intelligence (AI) model to automatically analyze the architectural diagram; generating, based on a result of the analysis, a description of services associated with the project and an explanation of dependencies and interactions among the services; comparing, based on the result of the analysis, the project with each of a set of security standards and a set of compliance requirements; generating, based on the result of the analysis, recommendations for improving a performance associated with the project; and generating a report based on the description, the explanation, a result of the comparison, and the recommendations.

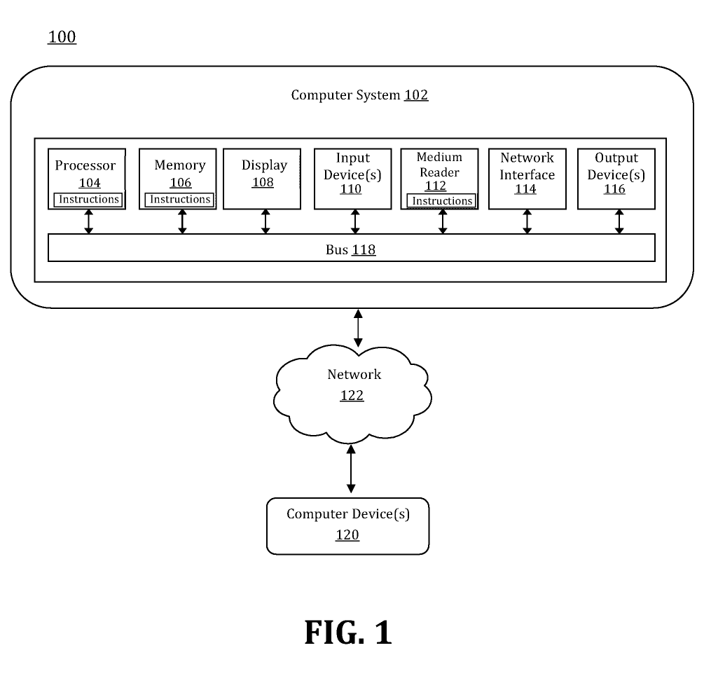

FIG. 1 is an exemplary system 100 for use in implementing a method for automatically converting an architectural diagram into structured text that includes analysis of project flaws, technical gaps, and compliance with applicable guidelines, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such a cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the modules implemented by the system 100 may be platform, language, database, and cloud agnostic that may allow for consistent easy orchestration and passing of data through various components to output a desired result regardless of platform, browser, language, database, and cloud environment by writing programs accordingly. The configuration or data files, in some embodiments, may be written using JavaScript Object Notation (JSON), but the disclosure is not limited thereto. For example, the configuration or data files may easily be extended to other readable file formats such as Extensible Markup Language (XML), YAML Ain’t Markup Language (YAML), etc., or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

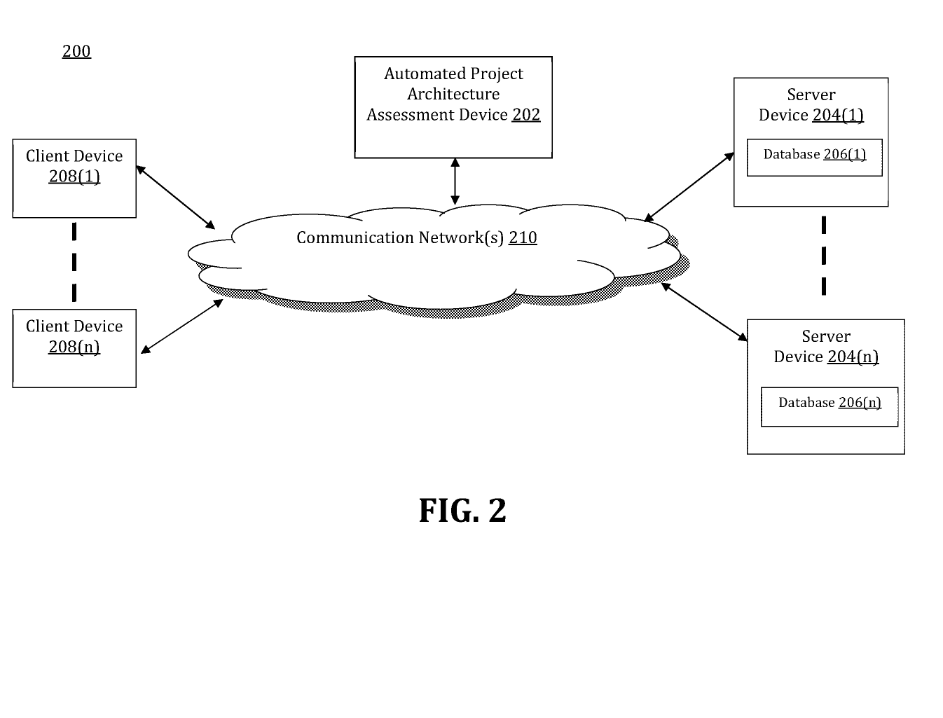

Referring to FIG. 2, a schematic of an exemplary network environment 200 for implementing an automated project architecture assessment device (APAAD) of the instant disclosure is illustrated.

In some embodiments, the above-described problems associated with conventional tools may be overcome by implementing an APAAD 202 as illustrated in FIG. 2 that may be configured for implementing a method for automatically converting an architectural diagram into structured text that includes analysis of project flaws, technical gaps, and compliance with applicable guidelines, but the disclosure is not limited thereto.

The APAAD 202 may have one or more computer system 102s, as described with respect to FIG. 1, which in aggregate provide the necessary functions.

The APAAD 202 may store one or more applications that can include executable instructions that, when executed by the APAAD 202, cause the APAAD 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the APAAD 202 itself, may be located in virtual server(s) running in a cloud-based computing environment rather than being tied to one or more specific physical network computing devices. Also, the application(s) may be running in one or more virtual machines (VMs) executing on the APAAD 202. Additionally, in one or more embodiments of this technology, virtual machine(s) running on the APAAD 202 may be managed or supervised by a hypervisor.

In the network environment 200 of FIG. 2, the APAAD 202 is coupled to a plurality of server devices 204(1)-204(n) that hosts a plurality of databases 206(1)-206(n), and also to a plurality of client devices 208(1)-208(n) via communication network(s) 210. A communication interface of the APAAD 202, such as the network interface 114 of the computer system 102 of FIG. 1, operatively couples and communicates between the APAAD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the APAAD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The APAAD 202 may be a standalone device or integrated with one or more other devices or apparatuses, such as one or more of the server devices 204(1)-204(n), for example. In one particular example, the APAAD 202 may be hosted by one of the server devices 204(1)-204(n), and other arrangements are also possible. Moreover, one or more of the devices of the APAAD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the APAAD 202 via the communication network(s) 210 according to the HyperText Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store various types of data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the APAAD 202 that may efficiently provide a platform for implementing a method for automatically converting an architectural diagram into structured text that includes analysis of project flaws, technical gaps, and compliance with applicable guidelines, but the disclosure is not limited thereto.

The client devices 208(1)-208(n) may run interface applications, such as standard web browsers or standalone client applications, which may provide an interface to communicate with the APAAD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the APAAD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the APAAD 202, the server devices 204(1)-204(n), or the client devices 208(1)-208(n), for example, may be configured to operate as virtual instances on the same physical machine. For example, one or more of the APAAD 202, the server devices 204(1)-204(n), or the client devices 208(1)-208(n) may operate on the same physical device rather than as separate devices communicating through communication network(s) 210. Additionally, there may be more or fewer APAADs 202, server devices 204(1)-204(n), or client devices 208(1)-208(n) than illustrated in FIG. 2. In some embodiments, the APAAD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

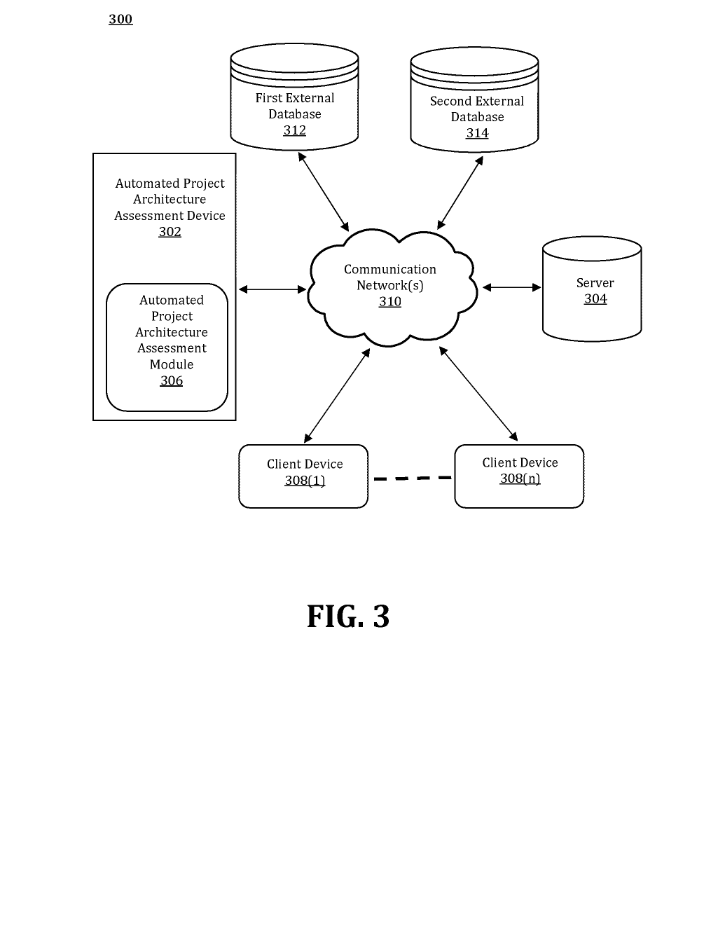

FIG. 3 illustrates a system diagram for implementing an APAAD 302 having an automated project architecture assessment module (APAAM), in accordance with an embodiment.

As illustrated in FIG. 3, the system 300 may include an APAAD 302 within which an APAAM 306 is embedded, a server 304, a first external database 312, a second external database 314, a plurality of client devices 308(1) … 308(n), and a communication network 310.

In some embodiments, the APAAD 302 including the APAAM 306 may be connected to the server 304, and the database(s) 312 via the communication network 310. The APAAD 302 may also be connected to the plurality of client devices 308(1) … 308(n) via the communication network 310, but the disclosure is not limited thereto.

In an embodiment, the APAAD 302 is described and shown in FIG. 3 as including the APAAM 306, although it may include other rules, policies, modules, databases, or applications, for example. In some embodiments, the first external database 312 and/or the second external database 314 may be configured to store ready to use modules written for each application programming interface (API) for all environments. Although only one database is illustrated in FIG. 3, the disclosure is not limited thereto. Any number of desired databases may be utilized for use in the disclosed invention herein. The databases 312, 314 may be a mainframe database, a log database that may produce programming for searching, monitoring, and analyzing machine-generated data via a web interface, etc., but the disclosure is not limited thereto.

In some embodiments, the APAAM 306 may be configured to receive real-time feed of data from the plurality of client devices 308(1) … 308(n) and secondary sources via the communication network 310.

As may be described below, the APAAM 306 may be configured to: receive an architectural diagram that relates to a project; using a generative artificial intelligence (AI) model to automatically analyze the architectural diagram; generate, based on a result of the analysis, a description of services associated with the project and an explanation of dependencies and interactions among the services; compare, based on the result of the analysis, the project with each of a set of security standards and a set of compliance requirements; generate, based on the result of the analysis, recommendations for improving a performance associated with the project; and generate a report based on the description, the explanation, a result of the comparison, and the recommendations, but the disclosure is not limited thereto.

The plurality of client devices 308(1) … 308(n) are illustrated as being in communication with the APAAD 302. In this regard, the plurality of client devices 308(1) … 308(n) may be “clients” (e.g., customers) of the APAAD 302 and are described herein as such. Nevertheless, it is to be known and understood that the plurality of client devices 308(1) … 308(n) need not necessarily be “clients” of the APAAD 302, or any entity described in association therewith herein. Any additional or alternative relationship may exist between either or both of the plurality of client devices 308(1) … 308(n) and the APAAD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) … 308(n) may communicate with the APAAD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The APAAD 302 may be the same or similar to the APAAD 202 as described with respect to FIG. 2, including any features or combination of features described with respect thereto.

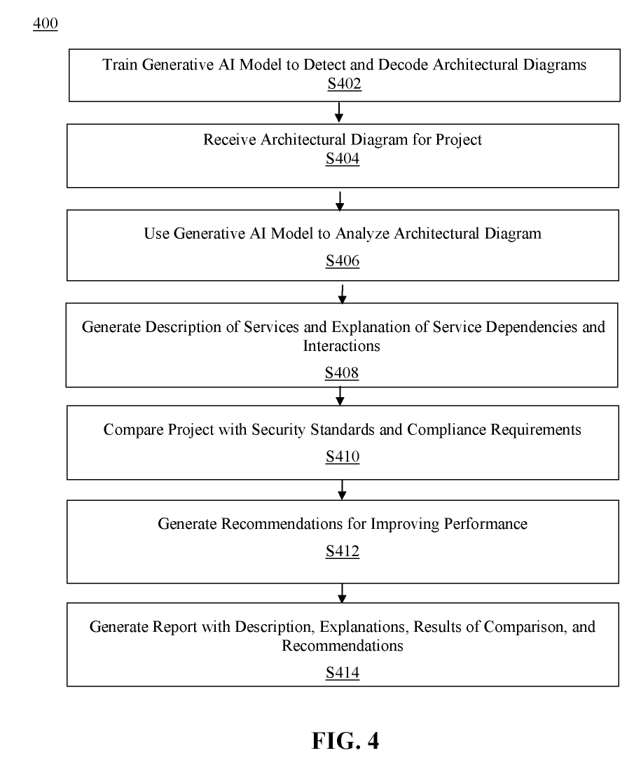

FIG. 4 illustrates an exemplary flow chart of a process 400 implemented by the APAAM 306 of FIG. 3 for enablement of a system and a method for automatically converting an architectural diagram into structured text that includes analysis of project flaws, technical gaps, and compliance with applicable guidelines, in accordance with an embodiment. It may be appreciated that the illustrated process 400 and associated steps may be performed in a different order, with illustrated steps omitted, with additional steps added, or with a combination of reordered, combined, omitted, or additional steps.

As illustrated in FIG. 4, at step S402, the process 400 may include training a a generative artificial intelligence (AI) model to detect and decode architectural diagrams. A detailed example of a training process is provided below. Then, at step S404, the process may include receiving an architectural diagram that is associated with a project. Then, at step S406, the process may include using the AI model to analyze the architectural diagram. In an embodiment, the generative AI model is pretrained to detect and recognize cloud service icons that may be included in the architectural diagram. In this regard, the AI model may be trained to use a convolutional neural network to detect patterns, shapes, and edges that correspond to particular cloud services, and to apply convolutional layers to highlight attributes of the cloud service icons. In addition, the AI model may also be trained to use a vision transformer to perform several functions, including capturing long-range dependencies among the cloud service icons; processing any particular architectural diagram as a series of patches and/or tokens in order to determine a structure and a layout of the particular architectural diagram; and providing positional encoding that corresponds to spatial relationships among the cloud service tokens.

At step S408, the process 400 may include using a result of the analysis performed in step S406 to generate a description of services associated with the project and an explanation of dependencies and interactions among those services. In an embodiment, the generation of the description may include detecting each of a set of icons included in the architectural diagram received in step S404, and cross-referencing each detected icon with a corresponding contextual embedding that is stored in a database or memory. In this regard, each respective contextual embedding may include textual information that is associated with the corresponding icon. In an embodiment, the description may include a respective purpose of each corresponding icon, a respective set of configurations for each corresponding icon, and a respective set of best practices for each corresponding icon.

At step S410, the process 400 may include comparing the project with each of a predetermined set of security standards and each of a predetermined set of compliance requirements. In an embodiment, when the project is associated with a financial transaction, the security standards may include a C1 context diagram that relates to system interactions with external entities, a C2 container diagram that relates to an architectural design of a cloud system, a C3 component diagram that relates to an internal structural design of containers within the cloud system, and a C4 code diagram that relates to an accuracy and a flexibility of the architectural design of the cloud system. However, the present inventive concept is not limited thereto, and any suitable types of security standards and/or compliance requirements may be applicable.

At step S412, the process 400 may include generating recommendations for improving performance with respect to the project. In an embodiment, the recommendations may include any one or more of a first recommendation that relates to a firewall rule associated with the project, a second recommendation that relates to data encryption associated with the project, and/or a third recommendation that relates to implementing an identity and access management (IAM) role associated with the project. In an embodiment, the recommendations may further include any one or more of a fourth recommendation that relates to scaling a configuration for a load balancer associated with the project and a fifth recommendation that relates to caching for a database service associated with the project. However, the present inventive concept is not limited thereto, and any suitable types of recommendations may be generated.

At step S414, the process 400 may include generating a report based on the description, the explanation, a result of the comparison with the security standards and compliance requirements, and the recommendations. In an embodiment, the process 400 may also include receiving a user input that relates to a focus area of the project, and the generation of the report may be tailored based on this received user input.

The following is a detailed description of the C1, C2, C3, and C4 diagrams:

C1 Context Diagram: In an embodiment, the C1 context diagram provides an ability to design a high-level overview of cloud-based systems, illustrating the interactions between the system and external entities such as users, third-party services, and on-premises systems. The C1 context diagram may define system boundaries and external dependencies, thereby ensuring that all stakeholders have a clear understanding of the system environment and its role within a broader ecosystem. The C1 context diagram may help align business objectives with technical architecture by identifying key stakeholders and external interfaces.

C2 Container Diagram: In an embodiment, the C2 container diagram provides an ability to design detailed architectures of cloud systems by decomposing them into major containers such as microservices, serverless functions, databases, and other cloud resources. The C2 container diagram may highlight a deployment of services and data storage solutions, thereby showing how different containers communicate and interact within the cloud environment. The C2 container diagram may support a selection of appropriate cloud services and infrastructure components, thereby ensuring scalability, reliability, and performance while aligning with a cloud strategy of an organization.

C3 Component Diagram: In an embodiment, the C3 component diagram provides an ability to design the internal structure of specific containers within cloud systems, detailing the components and their interactions within those containers. The C3 component diagram may focus on the design and organization of individual services or applications, thereby helping teams understand the responsibilities and relationships of microservices, modules, and/or functions. The C3 component diagram may support an implementation of best practices in software design, thus ensuring modularity, reusability, and maintainability of cloud-based applications.

C4 Code Diagram: In an embodiment, the C4 code diagram provides an ability to design accurate, flexible, and durable architecture designs that decompose applications into discrete modules using the API-first principle, and that align to a digital subscriber line (DSL) with clearly defined interfaces and boundaries. The C4 code diagram may produce a machine-readable output to ensure compliance and support automation across a software development life cycle (SDLC) tool chain.

The following is a detailed example of a training process for a generative AI model for use in accordance with an exemplary embodiment.

In an embodiment, a first module of the training process includes a vision module pretraining module. In this first module, a first step is to train the vision module on cloud service icons. For example, the generative AI model may be exposed to a dataset of cloud service icons from Amazon Web Services (AWS), Azure, and Google Cloud Platform (GCP). These icons may include services such as AWS Elastic Compute Cloud (EC2), Azure Virtual Machine (VM), and GCP Compute Engine.

Continuing with the first module, a second step involves a Convolutional Neural Network (CNN). In an embodiment, the CNN may focus on identifying essential icon features, such as intricate patterns, shapes, and edges unique to each cloud service icon. For example, for an AWS S3 icon, the CNN may highlight the bucket shape and the distinctive AWS logo. The CNN may also apply convolutional layers that emphasize distinct icon attributes, thereby facilitating faster and more accurate detection. The CNN may also utilize max pooling in order to reduce spatial dimensions while preserving important features, thereby increasing computational efficiency.

Continuing with the first module, a third step involves a Vision Transformer (ViT). In an embodiment, a self-attention mechanism of the ViT may capture long-range dependencies between icons, which may be crucial for complex architecture layouts. For example, in a diagram with multiple interconnected services, the ViT may understand the spatial relationships between an AWS Lambda function and an S3 bucket. The ViT may also process an image as patches, in view of an understanding of a global structure and layout across diagrams. The ViT may also perform a positional encoding in order to help remember spatial relationships, thereby enhancing recognition of interconnected icons.

In an embodiment, the ViT may also perform an icon context embedding. For example, an AWS EC2 icon may be embedded with metadata, such as service type and deployment region, providing context for its role in the architecture. The ViT may also perform a data augmentation. For example, icons may be rotated, scaled, and color-normalized to simulate real-world variations, thereby ensuring robustness in detection.

As a result, a pretrained Vision Module with high accuracy in identifying cloud service icons may be outputted, ready for further multimodal fusion with text-based descriptions.

In an embodiment, a second module of the training process includes a multimodal fusion (also referred to herein as “cross attention”). In an embodiment, a first step of the second module relates to cross-attention to align visual and textual data. For example, the generative AI model may align the visual features of an AWS relational database service (RDS) icon with its textual description, thus combining spatial information with semantic context.

Continuing with the second module, a second step may involve a cross-attention mechanism. In an embodiment, the cross-attention mechanism may include a visual-textual fusion that aligns detected icon features with corresponding service descriptions; attention weights that adjust dynamically based on relevance, prioritizing services and their roles; and token-level mapping that matches visual tokens with textual tokens, thereby ensuring comprehensive understanding.

Continuing with the second module, a third step may involve a role contextualization. For example, the role contextualization may distinguish between AWS EC2 and Azure VM by understanding contextual cues from surrounding text.

Continuing with the second module, a fourth step may involve hierarchical attention layers that capture both high-level and low-level details, thereby improving report accuracy. A fifth step may involve enhancing report quality by combining icons and descriptions to produce detailed insights, including functional roles and performance suggestions. Finally, in a sixth step, as a result, a model that integrates visual and textual information to generate informed, context-aware technical reports is an output of the second module.

In an embodiment, a third module of the training process includes training on a complete architecture diagram. In an embodiment, a first step of the third module relates to data preparation. For example, the data preparation step may include pairing architecture diagrams with human-labeled reports and annotating a role and a relationship of each service.

Continuing with the third module, a third step may involve an establishing an objective to enable understanding of service interactions, such as EC2 instances interacting with S3 data storage. A third step may involve hierarchical learning of relationships, such as, for example, learning of dependencies such as database replication and network routing. A fourth step may involve use of knowledge distillation, by which pre-trained large models guide the learning process for complex interactions.

Continuing with the third module, a fifth step may involve data augmentation for robustness, i.e., introducing synthetic variations to ensure robustness across diverse layouts. A sixth step may involve real-world scenarios, i.e., training on real-world diagrams, including single-cloud and multi-cloud environments. Finally, a seventh step may involve outputting a generative AI model that is capable of generating context-aware, detailed technical reports reflecting complex architectures.

In an embodiment, a fourth module of the training process includes C1/C4 infrastructure code translation in order to generate an explainability and recommendation inference. In an embodiment, a first step of the fourth module relates to an inference process. For example, the model may interpret a cloud architecture diagram by cross-referencing detected icons with stored contextual embeddings.

Continuing with the fourth module, a second step may involve generating a report structure. In an embodiment, the report structure may include: service descriptions that provide comprehensive details for each detected cloud service; inter-service interactions that explain relationships and dependencies; and performance recommendations for suggesting optimizations based on architecture patterns.

Continuing with the fourth module, a third step may involve security and compliance insights, in order to provide an analysis of the architecture against security standards and compliance requirements. A fourth step may involve a dynamic adjustment to diagram complexity, by which an adaptation to varying architecture complexity is generated, thereby providing summaries or detailed analyses as needed. A fifth step may involve use of natural language generation, i.e., generating clear, readable text, structuring reports for easy navigation. A sixth step may involve customization and parameter tuning, in order to allow users to specify focus areas, resulting in tailored reports. Finally, a seventh step may involve an outputting of a context-aware, detailed technical report covering functional descriptions, interactions, optimizations, and security, automating the cloud architecture documentation process.

In an embodiment, a fifth module of the training process includes prompt engineering and user customization for enhanced decoding. In an embodiment, a first step of the fifth module relates to integration of large language model (LLM) prompt engineering. For example, the enriched decoding from the fourth module may be utilized by applying LLM prompt engineering to further refine the interpretation of C1-C4 diagrams. This may include enhancing explainability, providing tailored recommendations, and identifying potential violations. This step may also include advanced decoding, by which the capabilities of LLM to interpret complex visual data and metadata are leveraged, thereby enhancing the clarity and depth of the architecture analysis.

Continuing with the fifth module, a second step may involve user input for customization. For example, users may be allowed and/or prompted to input specific parameters or select from predefined templates that align with project requirements or industry standards. In an embodiment, customizable templates may support various templates that cater to different industry regulations and project-specific needs, thereby ensuring that the architecture assessments are relevant and actionable.

Continuing with the fifth module, a third step may involve a compliance and recommendation engine. In an embodiment, this third step may include dynamic compliance checks in order to automatically assess the architecture against relevant compliance standards, highlighting any deviations or potential issues. The third step may also include tailored recommendations, by which specific suggestions for optimization and improvement are generated based on the unique characteristics of the architecture and user-defined goals.

Continuing with the fifth module, a third step may involve an enhanced user interaction. In an embodiment, the enhanced user interaction may include interactive prompts, in order to engage users with interactive prompts that guide them through the process of refining the analysis, thereby allowing for deeper insights and more precise adjustments; and feedback incorporation, i.e., integrating user feedback in real-time to continuously improve the accuracy and relevance of the architecture assessments.

Finally, a seventh step of the fifth module may involve an outputting of a detailed technical report, i.e., a comprehensive report that includes enhanced explainability of C1-C4 elements, customized recommendations, compliance assessments, and user-tailored insights. In an embodiment, the report may deliver actionable insights that are directly applicable to the project or industry, thereby facilitating informed decision-making and strategic planning.

The following is a detailed example of a technical assessment report that may be generated by executing a method for automatically converting an architectural diagram into structured text that includes analysis of project flaws, technical gaps, and compliance with applicable guidelines, in accordance with an exemplary embodiment.

Application Name: CJNav Workload.

High-Level Functionality: The CJNav Workload application is designed to manage and analyze digital journeys. This application allows digital testing analysts to view, create, and edit journeys. The application processes test scenario results, maps them into journeys, and stores JSON mappings. The application also includes batch processing to fetch test scenario executions and integrates with external software-as-a-service (SAAS) for knowledge management.

Architecture Overview: The example architecture includes several AWS services and components.

Component 1: CJNav UI, which functions as an interface for digital testing analysts to interact with the application.

Component 2: CJNav API, which functions as a backend service handling requests from the UI and other components.

Component 3: CJNav Batch Process, which runs daily to fetch the latest test scenario executions.

Component 4: JSON Mappings & Journeys, which stores journey data and JSON mappings.

Component 5: Journey Generator, which triggers on S3 events to update journeys.

Component 6: CJNav DB, which functions as a database for storing journey and test scenario data.

Component 7: External SAAS, which provides integration with an external knowledge management system.

Security and Compliance Assessment:

Logging: Ensure all server, serverless event, and application logs are onboarded to Datadog and Splunk.

Execution Policies: Ensure correct execution policies and real-time processing units (RPUs) are defined.

Minimum Necessary Access: Policies should have the minimum necessary level of access.

Multi-Region Deployment: Consider deploying to at least two recommended regions.

Internet Access: Ensure the application is not internet-facing and uses Transit Gateway for external connections.

Market Standards and Good Practices:

Encryption: Ensure data at rest and in transit is encrypted.

IAM Roles: Use IAM roles with least privilege access.

Security Groups: Properly configure security groups to restrict access.

### Scalability

Auto Scaling: Ensure EC2 instances and Lambda functions are configured with auto-scaling to handle varying loads.

S3 and Aurora: Both services are inherently scalable, but ensure Aurora is configured with read replicas if necessary.

### Performance

Caching: Implement caching mechanisms to reduce database load.

Monitoring: Use CloudWatch to monitor performance metrics and set up alarms for anomalies.

### Cost Optimization Assessment

Right-Sizing: Ensure EC2 instances and Aurora DB instances are right-sized based on usage patterns.

Reserved Instances: Consider using reserved instances for predictable workloads to reduce costs.

S3 Storage Classes: Use appropriate S3 storage classes for cost savings.

Reliability and Availability Assessment:

Multi-Availability Zone (AZ) Deployment: Ensure Aurora DB is deployed in Multi-AZ for high availability.

Backup and Restore: Implement regular backups and test restore procedures.

Fault Tolerance: Design the architecture to handle failures gracefully, such as using S3 for durable storage and Lambda for stateless processing.

In some embodiments as disclosed above in FIGS. 1-4, technical improvements effected by the instant disclosure may include a platform for automatically converting an architectural diagram into structured text that includes analysis of project flaws, technical gaps, and compliance with applicable guidelines, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for automatically converting an architectural diagram into a textual document, the method being implemented by at least one processor, the method comprising:
receiving a first architectural diagram that relates to a first project;
using a generative artificial intelligence (AI) model to automatically analyze the first architectural diagram;
generating, based on a result of the analysis, a description of at least one service associated with the first project and an explanation of dependencies and interactions among each of the at least one service;
comparing, based on the result of the analysis, the first project with each of a predetermined set of security standards and a predetermined set of compliance requirements;
generating, based on the result of the analysis, at least one recommendation for improving a performance associated with the first project; and
generating a report based on the description, the explanation, a result of the comparison, and the at least one recommendation.

2. The method of claim 1, wherein the generating of the description comprises detecting each of a plurality of icons included in the first architectural diagram and cross-referencing each detected icon with a corresponding contextual embedding that is stored in a database.

3. The method of claim 2, wherein the generating of the description further comprises generating, for each of the at least one service, a corresponding purpose, a corresponding set of configurations, and a corresponding set of best practices.

4. The method of claim 1, further comprising training the generative AI model by:
using a convolutional neural network to recognize cloud service icons by detecting patterns, shapes, and edges that correspond to particular cloud services and applying convolutional layers to highlight attributes of the cloud service icons; and
using a vision transformer to:
capture long-range dependencies between the cloud service icons;
process a training diagram as a series of tokens in order to determine a structure and a layout of the training diagram; and
provide positional encoding that corresponds to spatial relationships among the cloud service icons.

5. The method of claim 4, further comprising further training the generative AI model by:
performing a cross-attention operation that includes aligning visual data with corresponding textual data for each of the cloud service icons;
performing a role contextualization operation that distinguishes between at least a first one of the cloud service icons and at least a second one of the cloud service icons;
using hierarchical attention layers to capture details that relate to the cloud service icons; and
generating insights that include functional roles and performance suggestions for each of the cloud service icons.

6. The method of claim 1, wherein the predetermined set of security standards includes a C1 context diagram that relates to system interactions with external entities, a C2 container diagram that relates to an architectural design of a cloud system, a C3 component diagram that relates to an internal structural design of containers within the cloud system, and a C4 code diagram that relates to an accuracy and a flexibility of the architectural design of the cloud system.

7. The method of claim 1, further comprising receiving a user input that relates to at least one focus area of the first project,
wherein the generating of the report comprises tailoring the report based on the received user input.

8. The method of claim 1, wherein the at least one recommendation includes at least one from among a first recommendation that relates to a firewall rule associated with the first project, a second recommendation that relates to data encryption associated with the first project, and a third recommendation that relates to implementing an identity and access management (IAM) role associated with the first project.

9. The method of claim 7, wherein the at least one recommendation further includes at least one from among a fourth recommendation that relates to scaling a configuration for a load balancer associated with the first project and a fifth recommendation that relates to caching for a database service associated with the first project.

10. A computing apparatus for automatically converting an architectural diagram into a textual document, the computing apparatus comprising:
a processor;
a memory; and
a communication interface coupled to each of the processor and the memory,
wherein the processor is configured to:
receive, via the communication interface, a first architectural diagram that relates to a first project;
use a generative artificial intelligence (AI) model to automatically analyze the first architectural diagram;
generate, based on a result of the analysis, a description of at least one service associated with the first project and an explanation of dependencies and interactions among each of the at least one service;
compare, based on the result of the analysis, the first project with each of a predetermined set of security standards and a predetermined set of compliance requirements;
generate, based on the result of the analysis, at least one recommendation for improving a performance associated with the first project; and
generate a report based on the description, the explanation, a result of the comparison, and the at least one recommendation.

11. The computing apparatus of claim 10, wherein the processor is further configured to generate the description by detecting each of a plurality of icons included in the first architectural diagram and cross-referencing each detected icon with a corresponding contextual embedding that is stored in a database.

12. The computing apparatus of claim 11, wherein the processor is further configured to generate the description by generating, for each of the at least one service, a corresponding purpose, a corresponding set of configurations, and a corresponding set of best practices.

13. The computing apparatus of claim 10, wherein the processor is further configured to train the generative AI model by:
using a convolutional neural network to recognize cloud service icons by detecting patterns, shapes, and edges that correspond to particular cloud services and applying convolutional layers to highlight attributes of the cloud service icons; and
using a vision transformer to:
capture long-range dependencies between the cloud service icons;
process a training diagram as a series of tokens in order to determine a structure and a layout of the training diagram; and
provide positional encoding that corresponds to spatial relationships among the cloud service icons.

14. The computing apparatus of claim 13, wherein the processor is further configured to further train the generative AI model by:
performing a cross-attention operation that includes aligning visual data with corresponding textual data for each of the cloud service icons;
performing a role contextualization operation that distinguishes between at least a first one of the cloud service icons and at least a second one of the cloud service icons;
using hierarchical attention layers to capture details that relate to the cloud service icons; and
generating insights that include functional roles and performance suggestions for each of the cloud service icons.

15. The computing apparatus of claim 10, wherein the predetermined set of security standards includes a C1 context diagram that relates to system interactions with external entities, a C2 container diagram that relates to an architectural design of a cloud system, a C3 component diagram that relates to an internal structural design of containers within the cloud system, and a C4 code diagram that relates to an accuracy and a flexibility of the architectural design of the cloud system.

16. The computing apparatus of claim 10, wherein the processor is further configured to:
receive, via the communication interface, a user input that relates to at least one focus area of the first project; and
tailor the report based on the received user input.

17. The computing apparatus of claim 10, wherein the at least one recommendation includes at least one from among a first recommendation that relates to a firewall rule associated with the first project, a second recommendation that relates to data encryption associated with the first project, and a third recommendation that relates to implementing an identity and access management (IAM) role associated with the first project.

18. The computing apparatus of claim 17, wherein the at least one recommendation further includes at least one from among a fourth recommendation that relates to scaling a configuration for a load balancer associated with the first project and a fifth recommendation that relates to caching for a database service associated with the first project.

19. A non-transitory computer readable storage medium storing instructions for automatically converting an architectural diagram into a textual document, the storage medium comprising executable code which, when executed by a processor, causes the processor to:
receive a first architectural diagram that relates to a first project;
use a generative artificial intelligence (AI) model to automatically analyze the first architectural diagram;
generate, based on a result of the analysis, a description of at least one service associated with the first project and an explanation of dependencies and interactions among each of the at least one service;
compare, based on the result of the analysis, the first project with each of a predetermined set of security standards and a predetermined set of compliance requirements;
generate, based on the result of the analysis, at least one recommendation for improving a performance associated with the first project; and
generate a report based on the description, the explanation, a result of the comparison, and the at least one recommendation.

20. The storage medium of claim 19, wherein when executed, the executable code further causes the processor to generate the description by detecting each of a plurality of icons included in the first architectural diagram and cross-referencing each detected icon with a corresponding contextual embedding that is stored in a database.
